(19) United States
(12) Patent Application Publication
(10) Pub. No.: US 2010/0318811 A1
(43) Pub. Date: Dec. 16, 2010

(54) CRYPTOGRAPHIC PROCESSOR

(75) Inventor: Masahiko Motoyama, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/722,887

(22) Filed: Mar. 12, 2010

(30) Foreign Application Priority Data
Jun. 15, 2009 (JP) 2009-142622

(51) Int. Cl. G06F 21/22; G06F 7/58; H04L 9/28

(52) U.S. Cl. 713/190; 708/250; 380/29

(57) ABSTRACT

A cryptographic processor includes: first and second round function operation circuits, each of which executes cryptographic processing; and a control circuit configured to operate the first and second round function operation circuits by randomly switching between a parallel operation mode used to operate the first and second round function operation circuits in parallel and a serial operation mode used to operate the first and second round function operation circuits in series.

### CROSS-REFERENCE TO RELATED APPLICATIONS

This application is based upon and claims the benefit of priority from the prior Japanese Patent Application No. 2009-142622 filed in Japan on Jun. 15, 2009; the entire contents of which are incorporated herein by this reference.

### BACKGROUND OF THE INVENTION

1. Field of the Invention

The present invention relates to a cryptographic processor and, more particularly, to a cryptographic processor immune to power analysis attacks.

2. Description of the Related Art

Conventionally, a method, known as power analysis, has been available to draw out confidential information used in a cryptographic processor from electric power consumed therein. As a measure against such an analysis method, a technique referred to as a data masking method, which is disclosed in, for example, Japanese Patent Application Laid-Open Publication No. 2000-66585, has been proposed. According to the data masking method, a random number generating circuit generates random numbers as mask data and a cryptographic processing circuit executes cryptographic processing, while performing data masking using the mask data supplied from the random number generating circuit.

In general, the data masking method performs cryptographic processing by executing an EXCLUSIVE-OR operation or the like on input plain text and mask data, which are random numbers, to convert the input plain text into irrelevant data, thereby enhancing immunity to power analysis attacks.

In the cryptographic processor in accordance with the above-described proposal, two S functions, which are part of DES cryptographic operations, are used and switched between at random, thereby providing the apparatus with immunity to power analysis attacks.

However, the cryptographic processor mentioned in the proposal remains the same in processing time as conventional apparatuses, whereas the apparatus' circuit scale for an S function part is twice as large.

### BRIEF SUMMARY OF THE INVENTION

According to one aspect of the present invention, there can be provided a cryptographic processor including:

first and second cryptographic operation circuits, each of which executes cryptographic processing; and

a control circuit configured to operate the first and second cryptographic operation circuits by randomly switching between a parallel operation mode used to operate the first and second cryptographic operation circuits in parallel and a serial operation mode used to operate the first and second cryptographic operation circuits in series.

### BRIEF DESCRIPTION OF THE DRAWINGS

FIG. 1 is a configuration diagram illustrating a configuration of a cryptographic processor 1 in accordance with an embodiment of the present invention;

FIG. 2 is a block diagram illustrating a configuration of a cryptographic circuit module 15 in accordance with an embodiment of the present invention;

FIGS. 3A to 3C are timing diagrams used to explain examples of operations based on switching between a parallel operation mode PM and a serial operation mode SM in an embodiment of the present invention;

FIG. 4 is a block diagram illustrating a configuration example of a cryptographic circuit module 15A of a cryptographic processor in accordance with a modified example of an embodiment of the present invention; and

FIGS. 5A and 5B are timing diagrams used to explain examples of operations based on switching between a parallel operation mode PM and a serial operation mode SM in a modified example of an embodiment of the present invention.

### DETAILED DESCRIPTION OF THE INVENTION

Hereinafter, an embodiment of the present invention will be described with reference to the accompanying drawings.

### (Configuration)

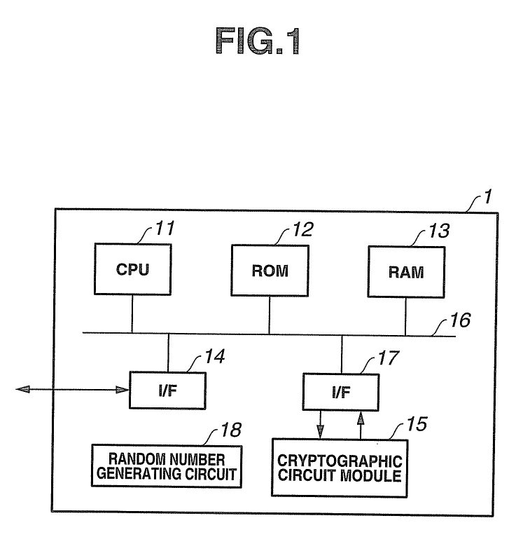

First, a configuration of a cryptographic processor equipped with cryptographic processing circuits in accordance with an embodiment of the present invention will be described based on FIG. 1. FIG. 1 is a configuration diagram illustrating the configuration of a cryptographic processor 1 in accordance with the present embodiment.

The cryptographic processor 1 includes a central processing unit (CPU) 11; a ROM 12 in which programs and the like are stored; a RAM 13 serving as a working storage area of the CPU 11; a transmission/reception interface circuit (hereinafter abbreviated as transmission/reception I/F) 14 used to exchange data with an external unit; a cryptographic circuit module 15 including cryptographic processing circuits; a cryptographic circuit I/F 17 which interfaces between the cryptographic circuit module 15 and a bus 16; and a random number generating circuit 18 configured to generate random numbers. The CPU 11, the ROM 12, the RAM 13, the transmission/reception I/F 14, and the cryptographic circuit I/F 17 are connected to one another through the bus 16.

The cryptographic processor 1 is, for example, an IC (Integrated Circuit) card. Upon receipt of data from an external unit (not illustrated), such as a card reader unit, the cryptographic processor 1 performs predetermined cryptographic processing on the data and outputs or transmits data resulting from the cryptographic processing. Data exchange with the external unit is made by means of radio communication through the transmission/reception I/F 14, for example, through an unillustrated circuit for radio communication.

In addition, data exchanged between the CPU 11 and the cryptographic circuit module 15 is also encrypted.

The cryptographic circuit module 15 includes two cryptographic processing circuits and performs encryption processing and/or decryption processing. The cryptographic processing circuits in accordance with the present embodiment use the round functions of the DES (Data Encryption Standard). In addition to data, a round key (extended key) to be input at each round is input to a DES round function as key data.

The random number generating circuit 18 generates and outputs random numbers.

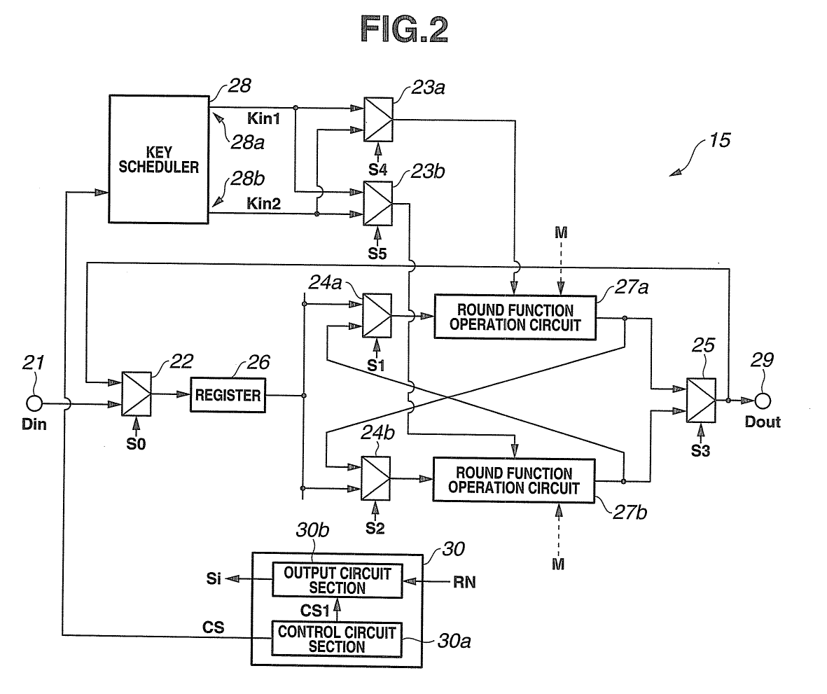

FIG. 2 is a block diagram illustrating the configuration of the cryptographic circuit module 15.

As illustrated in FIG. 2, the cryptographic circuit module 15 includes an input terminal 21, selectors 22, 23a, 23b, 24a, 24b and 25 which are selection circuits, a register 26, round function operation circuits 27a and 27b configured to calculate predetermined round functions, a key scheduler 28, an output terminal 29, and a control circuit 30.

The input terminal 21 is a terminal to which input data Din from the cryptographic circuit I/F 17 is input. The selector 22 is a circuit configured to select either an output resulting from round function operation or the input data Din, according to a selection signal S0, and output a selected output or data. The register 26 is a circuit to which an output of the selector 22 is input, so that the register 26 retains and outputs the input data Din or an intermediate result of round function operation.

The selector 24a is a circuit configured to select either an output of the register 26 or an output of the round function operation circuit 27b according to a selection signal S1 from the control circuit 30, as illustrated in FIG. 2. Likewise, the selector 24b is a circuit configured to select either an output of the register 26 or an output of the round function operation circuit 27a according to a selection signal S2 from the control circuit 30, as illustrated in FIG. 2.

The round function operation circuits 27a and 27b are configured to perform the cryptographic process of predetermined encryption operation processing or predetermined decryption operation processing. Accordingly, cryptographic processing refers to cipher processing or decipher processing. The round function operation circuit 27a and the round function operation circuit 27b respectively have an input terminal to which a round key Kin, which is key data from the key scheduler 28, is input.

At the start of cryptographic processing, the selector 22 is controlled by a selection signal S0 from the control circuit 30, so as to select input data Din from the input terminal 21 and output the input data Din to the register 26. In the course of round function operation, the selector 22 is controlled by the selection signal S0 from the control circuit 30, so as to select data resulting from round function operation and output the data to the register 26.

In the course of cryptographic processing, the register 26 retains the intermediate result of cryptographic processing. The output of the register 26 is input to one input terminal of each of the two selectors 24a and 24b. The output of the round function operation circuit 27b is input to the other input terminal of the selector 24a. The output of the round function operation circuit 27a is input to the other input terminal of the selector 24b.

An output of the selector 24a is supplied to the round function operation circuit 27a, and an output of the selector 24b is supplied to the round function operation circuit 27b.

The outputs of the round function operation circuits 27a and 27b are input to the selector 25. An output of the selector 25 is supplied to the other input terminal of the selector 22 and to an output terminal 29 as well. The final result of cryptographic processing is output as output data Dout from the output terminal 29.

The selectors 24a, 24b and 25 select one of two inputs from the control circuit 30, according respectively to selection signals S1, S2 and S3, and output a selected input.

The key scheduler 28 is a circuit configured to generate and output two round keys Kin1 and Kin2 on the basis of a control signal CS from the control circuit 30. The two round keys Kin1 and Kin2 are output respectively from the two output terminals 28a and 28b of the key scheduler 28. The two round keys Kin1 and Kin2 are input to the two selectors 23a and 23b. The two selectors 23a and 23b respectively select either one of the input two round keys Kin1 and Kin2, according respectively to selection signals S4 and S5 from the control circuit 30, and output a selected round key to the round function operation circuits 27a and 27b.

The selectors 23a and 23b are circuits configured to control the round keys Kin1 and Kin2 to be input to the two round function operation circuits. In the case of a parallel operation mode PM, the selectors 23a and 23b select and output round keys to be used in round function operations which are executed in the cycle in question, as will be described later. In the case of a serial operation mode SM, the selectors 23a and 23b are controlled so as to input a first round key to a round function operation circuit which is the first to perform operation processing in the cycle in question and to input a second round key to a round function operation circuit which performs operation processing later. That is, the two round function operation circuits operate at timings shifted from each other. For example, assume that the round function operation circuit 27b is the first to perform processing in a certain cycle and that the first round key is output from the first output terminal 28a and the second round key is output from the second output terminal 28b. Then, the selectors 23a and 23b are controlled so that the first round key is supplied to the round function operation circuit 27b and the second round key is supplied to the round function operation circuit 27a.

The control circuit 30 includes a control circuit section 30a and an output circuit section 30b. The control circuit 30 is configured to control the cryptographic circuit module 15, so that the cryptographic circuit module 15 performs cryptographic processing in two modes, i.e., the parallel operation mode PM and the serial operation mode SM.

The control circuit section 30a is configured to control the state of a round (for example, what round an execution cycle is in) in cryptographic processing, and output a control signal CS to the key scheduler 28 and a control signal CS1 to the output circuit section 30b.

Furthermore, the control circuit 30 outputs a selection signal Si (where, “i” is a number from 1 to 5) on the basis of random-number data RN from the random number generating circuit 18, in order to cause the round function operation circuits 27a and 27b to operate at random in the later-described parallel operation mode PM and serial operation mode SM.

In the case of FIG. 2, the random-number data RN is input to the output circuit section 30b. The output circuit section 30b is configured to generate and output a selection signal Si, so as to cause the round function operation circuits to operate in either the parallel operation mode PM or the serial operation mode SM, according to a value of the random-number data.

For example, the random-number data RN may be random data composed of “1s” and “0s”. A value “1” of the random-number data RN may be made to correspond to the parallel operation mode PM and a value “0” thereof may be made to correspond to the serial operation mode SM, so that the output circuit section 30b outputs the selection signal Si according to the mode in question.

### (Operation)

Next, a description will be given of an operation of the cryptographic circuit module 15 illustrated in FIG. 2.

The control circuit 30 makes the round function operation circuits 27a and 27b operate, while switching between the parallel operation mode PM and the serial operation mode SM at random, according to random numbers from the random number generating circuit 18.

When a round function operation is made in the parallel operation mode PM, both the selectors 24a and 24b select an output from the register 26. Accordingly, selection signals 51 and S2 are output from the control circuit 30 to the selectors 24a and 24b, so that the selectors 24a and 24b select the output of the register 26. Consequently, the output of the register 26 is input to the round function operation circuits 27a and 27b. The same data is thus input to the round function operation circuits 27a and 27b, where the data is processed respectively. The respective outputs of the round function operation circuits 27a and 27b are provided to the selector 25. The selector 25 selects either one of the outputs according to the selection signal S3, and outputs a selected output to the register 26.

When a round function operation is made in the serial operation mode SM, two cases of operation apply, depending on an operating sequence of the two round function operation circuits 27a and 27b. In a first case, the round function operation circuit 27a is the first to perform the operation, and then the round function operation circuit 27b performs an operation on the result of the operation in one cycle. In a second case, the round function operation circuit 27b is the first to perform the operation, and then the round function operation circuit 27a performs an operation on the result of the operation in one cycle.

In the first case where the round function operation circuit 27a is the first to perform an operation, the selector 24a provides an output from the register 26 to the round function operation circuit 27a. The round function operation circuit 27a performs cryptographic processing on the output from the register 26. Since the result of the cryptographic processing is also output to the selector 24b, the selector 24b supplies an output from the round function operation circuit 27a to the round function operation circuit 27b, according to the selection signal S2. The round function operation circuit 27b performs cryptographic processing on the output from the round function operation circuit 27a and outputs the result of the cryptographic processing to the selector 25. An output from the round function operation circuit 27a and an output from the round function operation circuit 27b are input to the selector 25. The selector 25 selects the output from the round function operation circuit 27b and provides an output to the register 26, according to the selection signal S3. The register 26 retains a result output from the selector 25.

In the second case where the round function operation circuit 27b is the first to perform an operation, the selector 24b provides an output from the register 26 to the round function operation circuit 27b. The round function operation circuit 27b performs cryptographic processing on the output from the register 26. Since the result of the cryptographic processing is also output to the selector 24a, the selector 24a supplies the output from the round function operation circuit 27b to the round function operation circuit 27a, according to the selection signal S1. The round function operation circuit 27a performs cryptographic processing on the output from the round function operation circuit 27b and outputs the result of the cryptographic processing to the selector 25. An output from the round function operation circuit 27b and an output from the round function operation circuit 27a are input to the selector 25. The selector 25 selects the output from the round function operation circuit 27a and provides an output to the register 26, according to the selection signal S3.

The control circuit 30 constitutes a changeover control section configured to switch the operating mode of the cryptographic processing circuits between the parallel operation mode PM and the serial operation mode SM, on the basis of random numbers from the random number generating circuit 18.

The control circuit 30 outputs the control signal CS to the key scheduler 28, while controlling the state of a round. The control signal CS contains data indicating information on rounds. That is, the key scheduler 28 outputs round keys according to the state of a round from the two output terminals, on the basis of the control signal CS from the control circuit 28.

In the case of the parallel operation mode PM, the key scheduler 28 outputs the same data from the two output terminals 28a and 28b. In the case of the serial operation mode SM, the key scheduler 28 outputs different data from the two output terminals 28a and 28b. In the case of the serial operation mode SM, in particular, the key scheduler 28 outputs round keys corresponding respectively to the two round function operation circuits, according to the first and second cases.

For example, if a third round is executed in the parallel operation mode PM, key data for a third round key is output from the two output terminals 28a and 28b of the key scheduler 28. If fourth and fifth rounds are executed in the serial operation mode SM, key data for a fourth round key is output from one output terminal of the key scheduler 28 to a round function operation circuit that performs a fourth-round cryptographic operation and key data for a fifth round key is output from the other output terminal of the key scheduler 28 to a round function operation circuit that performs a fifth-round cryptographic operation.

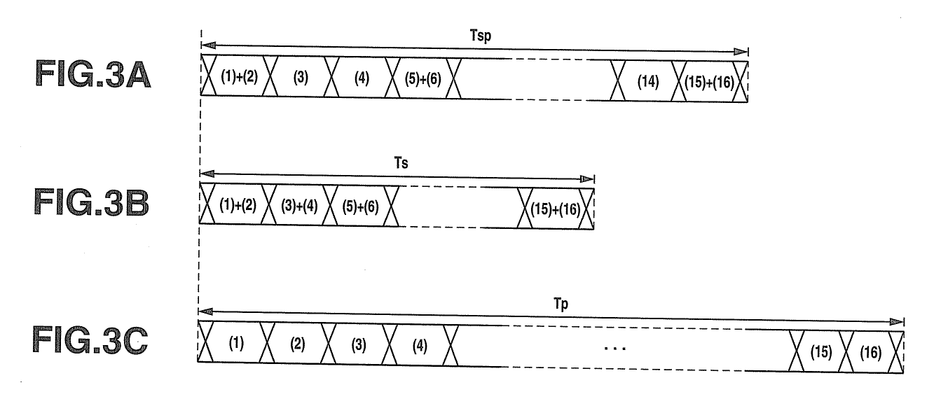

FIGS. 3A to 3C are timing diagrams used to explain examples of operations based on switching between the parallel operation mode PM and the serial operation mode SM in the present embodiment.

According to the above-described cryptographic circuit module 15 illustrated in FIG. 2, the parallel operation mode PM and the serial operation mode SM are executed at random on the basis of the random number RN. In other words, the operating mode of a cryptographic processing circuit changes at random to the parallel operation mode PM or the serial operation mode SM. For example, in the example illustrated in FIG. 3A, first and second rounds are executed in the serial operation mode SM in a first cycle. In the next cycle, a third round is executed in the parallel operation mode PM, a fourth round is executed also in the parallel operation mode PM in the next cycle. In the next cycle, fifth and sixth rounds are executed in the serial operation mode SM. Then, in a cycle second to the last, a 14th round is executed in the parallel operation mode PM. In the last cycle, 15th and 16th rounds are executed in the serial operation mode SM, thus completing cryptographic processing.

Since the parallel operation mode PM and the serial operation mode SM are executed on the basis of the random number RN, all cycles may coincide with the serial operation mode SM (the case illustrated in FIG. 3B) or with the parallel operation mode PM (the case illustrated in FIG. 3C). Under normal conditions, however, probability of all cycles being coincident with the serial operation mode SM (the case illustrated in FIG. 3B) or with the parallel operation mode PM (the case illustrated in FIG. 3C) is low. Thus, each sequence of cryptographic processing contains both the parallel operation mode PM and the serial operation mode SM at random.

Accordingly, under normal conditions, an overall cryptographic processing time Tsp is longer than a time Ts required in the case of FIG. 3B where the serial operation mode SM is executed in all cycles, but shorter than a time Tp required in the case of FIG. 3C where the parallel operation mode PM is executed in all cycles.

In addition, the parallel operation mode PM and the serial operation mode SM are executed while being switched between at random and, therefore, immunity to power analysis attacks is secured. Furthermore, the two operating modes are combined at random and, therefore, an overall processing time required in cryptographic processing varies, thereby making it difficult to synchronize timings of power analysis. Thus, immunity to power analysis attacks is high also in that regard.

As described above, according to the present embodiment, it is possible to provide a cryptographic processor capable of reducing a processing time, while securing immunity to power analysis attacks.

Next, a description will be given of modified examples of the cryptographic processor in accordance with the above-described embodiment. The cryptographic processor in accordance with the above-described embodiment may be partially modified or partial additions may be made to the apparatus, as will be described hereinafter.

### Modified Example 1

A cryptographic processor in accordance with the present modified example is configured so that cryptographic operations using a dummy round key, i.e., dummy operations are interposed at random between execution cycles of two modes.

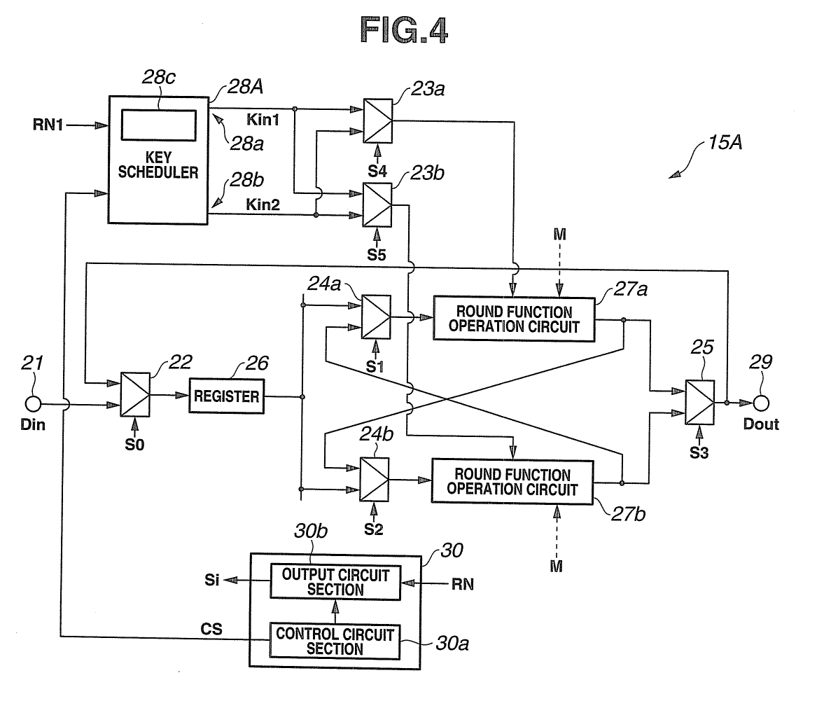

FIG. 4 is a block diagram illustrating a configuration example of a cryptographic circuit module 15A of the cryptographic processor in accordance with the present modified example. The same components as those of FIG. 2 are denoted by like numerals and will not be explained again.

In FIG. 4, a random number RN1 from a random number generating circuit 18 is input to a key scheduler 28A. The key scheduler 28A includes a dummy generating section 28c configured to generate and output dummy round keys at the time of a serial operation mode SM, according to the input random number RN1. Note that the random number RN1 may be either the same as or different from the random number RN mentioned earlier.

Algorithms used in the DES, AES and the like, characteristically have the nature that if round processing for encryption and round processing for decryption are performed using the same key, data reverts to the original state thereof (i.e., output data equals input data). Consequently, by taking advantage of this nature, two round function operation circuits execute a cycle of dummy operations, in which round operations are performed, at the time of the serial operation mode SM which takes place at random, using round keys generated based on the random number RN1. In addition, a timing at which the dummy generating section 28c outputs the dummy round keys (i.e., a timing at which a dummy operation cycle is interposed) is also determined based on the random number RN1.

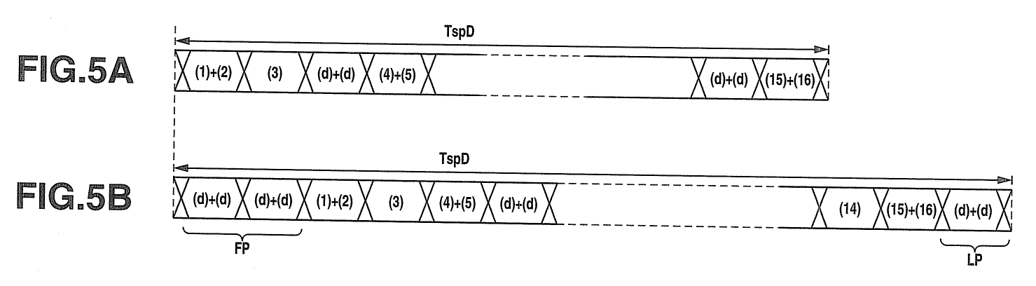

FIGS. 5A and 5B are timing diagrams used to explain examples of operations based on switching between the parallel operation mode PM and the serial operation mode SM in the present modified example.

According to the above-described cryptographic circuit module 15A illustrated in FIG. 4, the parallel operation mode PM and the serial operation mode SM are mixedly executed at random based on the random number RN, and dummy operation cycles are interposed at random based on the random number RN1. For example, in the example illustrated in FIG. 5A, first and second rounds are executed in the serial operation mode SM first, and then a third round is executed in the parallel operation mode PM. Next, dummy operations are executed in the serial operation mode SM, and then fourth and fifth rounds are executed in the serial operation mode SM. Subsequently, dummy operations are executed after a 14th round and, finally, 15th and 16th rounds are executed in the serial operation mode SM, thus completing cryptographic processing.

As described above, the parallel operation mode PM and the serial operation mode SM are mixedly executed at random based on the random number RN. In addition, dummy operation cycles are interposed at random based on random numbers. Consequently, it is possible to realize a cryptographic processor capable of reducing a processing time, while securing higher immunity to power analysis attacks than is available in the above-described embodiment.

Furthermore, one or more dummy operation cycles may always be added to at least either one of the first and last parts of cryptographic operation processing. This is because power analysis attacks are often made at the time of executing the first and last parts, i.e., the first and 16th rounds here.

FIG. 5B illustrates an example in which more than one dummy operation cycle is added to the first part FP of cryptographic operation processing (i.e., a part preceding the first round). While in FIG. 5B, two dummy operation cycles are added to the first part FP, the number of dummy operation cycles to be added is determined according to the random number RN1.

In addition, FIG. 5B illustrates an example in which a dummy operation cycle is added to the last part LP of cryptographic operation processing (i.e., a part preceded by the 16th round). While in FIG. 5B, one dummy operation cycle is added to the last part LP, the number of dummy operation cycles to be added is determined according to the random number RN1.

In this way, one or more dummy operation cycles are always added to both the first and last parts or to at least one of the first and last parts. The number of dummy operation cycles to be added is determined at random.

As described above, by interposing dummy operations between execution cycles of the parallel operation mode PM and the serial operation mode SM and adding dummy operations to the first and last parts of cryptographic operation processing, it is possible to realize a cryptographic processor capable of reducing a processing time, while securing even higher immunity to power analysis attacks.

Note that it is also possible to realize a cryptographic processor capable of reducing a processing time, while securing higher immunity to power analysis attacks, even by either interposing or adding dummy operations.

### Modified Example 2

The cryptographic processor in accordance with the present modified example is configured so that cryptographic processing is performed using mask data in round function operations.

The present modified example is such that in a cryptographic processor in accordance with the above-described embodiment or modified example 1, cryptographic processing based on a data masking method is applied. Specifically, mask data is input to each round function operation circuit and cryptographic processing is executed, while data masking is being performed using the mask data.

In FIG. 2 or FIG. 4, mask data M is input to the round function operation circuits 27a and 27b, as shown by dotted lines. The mask data M is generated using random numbers output from the random number generating circuit 18. Note that the random numbers used to generate the mask data M may be either the same as or different from the random number RN mentioned earlier.

As the data masking method, it is possible to use such a method as described in Japanese Patent Application Laid-Open Publication No. 2000-66585 (Japanese Patent No. 3600454). In that case, unlike the method described in the publication, a circuit configuration can be applied in which a first cryptographic operation circuit performs cryptographic operations using a first mask pattern alone and a second cryptographic operation circuit performs cryptographic operations using a second mask pattern alone. In the serial operation mode, it is possible to perform cryptographic processing at speeds higher than those available in the method described in the aforementioned publication. In the parallel operation mode, the speed of cryptographic processing is the same as that available in the method described in the aforementioned publication.

According to the present modified example, an improvement in immunity based on data masking is further added in the cryptographic processor in accordance with the above-described embodiment or modified example 1. Thus, it is possible to secure even higher immunity to power analysis attacks.

Note that the cryptographic processors in accordance with the above-described embodiment and the two modified examples are cryptographic processors which use DES round functions. However, a cryptographic processing method is not limited to the DES but other methods may be used.

For example, the AES (Advanced Encryption Standard) can be used as the cryptographic processing method. In the case of the DES, the same operation circuit is used for both encryption and decryption. In the case of the AES, however, a cryptographic processor is configured so that each of two cryptographic operation circuits includes two operation circuits for encryption and decryption and the cryptographic processing method is carried out while the two operation circuits are being switched between each other. In that case, a signal representing an instruction from the control circuit 30 as to which operation circuit to use, one for encryption or one for decryption, is included in a control signal. In the case of the above-described modified example 1 in which dummy round keys are used, the control circuit 30 controls the two round function operation circuits 27a and 27b and the key scheduler 28A, so that one of the two operation circuits is used for encryption, the other operation circuit is used for decryption, and different round keys are supplied to the respective operation circuits.

Note further that the cryptographic processors in accordance with the above-described embodiment and the two modified examples are examples each of which includes two operation circuits for encryption (specifically, the round function operation circuits 27a and 27b). Alternatively, each of the apparatuses may include three or more operation circuits for encryption.

In the above-described embodiment and respective modified examples, an explanation has been made by taking an IC card as an example of each cryptographic processor, the cryptographic processor may be an apparatus of another type.

As has been described heretofore, according to the above-described embodiment and respective modified examples of the present invention, it is possible to realize a cryptographic processor capable of reducing a processing time, while securing immunity to power analysis attacks.

The present invention is not intended to be limited to the above-described embodiment, but may be modified or altered in various ways within the scope of not changing the gist of the invention.

What is claimed is:

1. A cryptographic processor comprising:
first and second cryptographic operation circuits, each of which executes cryptographic processing; and
a control circuit configured to operate the first and second cryptographic operation circuits by randomly switching between a parallel operation mode used to operate the first and second cryptographic operation circuits in parallel and a serial operation mode used to operate the first and second cryptographic operation circuits in series.

2. The cryptographic processor according to claim 1, including a random number generating circuit configured to generate random numbers, wherein the control circuit switches between the parallel operation mode and the serial operation mode at random on the basis of the random numbers output from the random number generating circuit.

3. The cryptographic processor according to claim 2, wherein the control circuit interposes dummy operations at random between execution cycles of the parallel operation mode and the serial operation mode.

4. The cryptographic processor according to claim 3, wherein the dummy operations are interposed at random on the basis of random numbers.

5. The cryptographic processor according to claim 1, wherein the control circuit interposes one or more dummy operations before the execution of the cryptographic processing, after the execution of the cryptographic processing, or before and after the execution of the cryptographic processing.

6. The cryptographic processor according to claim 3, wherein the control circuit interposes one or more dummy operations before the execution of the cryptographic processing, after the execution of the cryptographic processing, or before and after the execution of the cryptographic processing.

7. The cryptographic processor according to claim 1, wherein the first and second cryptographic operation circuits respectively execute the cryptographic processing, while performing data masking using mask data generated on the basis of random numbers.

8. The cryptographic processor according to claim 3, wherein the first and second cryptographic operation circuits respectively execute the cryptographic processing, while performing data masking using mask data generated on the basis of random numbers.

9. The cryptographic processor according to claim 1, wherein the first and second cryptographic operation circuits respectively include round function operation circuits for encryption and decryption utilizing the AES (Advanced Encryption Standard).

10. The cryptographic processor according to claim 9, including a key scheduler configured to generate round keys for the round function operation circuits, wherein data on the generated round keys is input to the first and second cryptographic operation circuits, respectively.

11. The cryptographic processor according to claim 1, wherein the first and second cryptographic operation circuits utilize the DES (Data Encryption Standard).

12. The cryptographic processor according to claim 11, including a key scheduler configured to generate round keys for the round function operation circuits, wherein data on the generated round keys is input to the first and second cryptographic operation circuits, respectively.

13. The cryptographic processor according to claim 1, including:
a register;
a first selector, to which an output of the second cryptographic operation circuit and an output of the register are input, so that the first selector selects either one of the two outputs thus input according to a first selection signal, and outputs a selected output;
a second selector, to which an output of the first cryptographic operation circuit and an output of the register are input, so that the second selector selects either one of the two outputs thus input according to a second selection signal, and outputs a selected output;
a third selector, to which outputs of the first and second cryptographic operation circuits are input, so that the third selector selects either one of the two outputs thus input according to a third selection signal, and outputs a selected output as output data; and
a fourth selector, to which input data serving as a target data of the cryptographic processing and the output data are input, so that the fourth selector selects either one of the input data and the output data thus input, according to a fourth selection signal, and outputs a selected data to the register,
wherein the control circuit outputs the first, second, third and fourth selection signals to the first, second, third and fourth selectors, respectively, and makes the first cryptographic operation circuit and the second cryptographic operation circuit operate, while switching between the parallel operation mode and the serial operation mode at random.

14. An IC card comprising:
first and second cryptographic operation circuits, each of which executes cryptographic processing; and
a control circuit configured to operate the first and second cryptographic operation circuits by randomly switching between a parallel operation mode used to operate the first and second cryptographic operation circuits in parallel and a serial operation mode used to operate the first and second cryptographic operation circuits in series.

15. A cryptographic processor comprising:
a CPU;
a ROM in which a program is stored;
a transmission/reception interface circuit configured to exchange data with an external unit; and
a cryptographic circuit module,
wherein the cryptographic circuit module includes:
first and second cryptographic operation circuits, each of which executes cryptographic processing; and
a control circuit configured to operate the first and second cryptographic operation circuits by randomly switching between a parallel operation mode used to operate the first and second cryptographic operation circuits in parallel and a serial operation mode used to operate the first and second cryptographic operation circuits in series.

16. The cryptographic processor according to claim 15, wherein the cryptographic processor is an IC card.

17. The cryptographic processor according to claim 15, including a random number generating circuit configured to generate random numbers, wherein the control circuit switches between the parallel operation mode and the serial operation mode at random on the basis of the random numbers output from the random number generating circuit.

18. The cryptographic processor according to claim 15, wherein the control circuit interposes dummy operations at random between execution cycles of the parallel operation mode and the serial operation mode.

19. The cryptographic processor according to claim 18, wherein the dummy operations are interposed at random on the basis of random numbers.

20. The cryptographic processor according to claim 15, wherein the first and second cryptographic operation circuits respectively execute the cryptographic processing, while performing data masking using mask data generated on the basis of random numbers.
